(19) United States
(12) Patent Application Publication
(10) Pub. No.: US 2026/0212258 A1
(43) Pub. Date: Jul. 23, 2026

(54) INFORMATION HANDLING SYSTEM WITH ESTIMATING AND ATTRIBUTING CONFIDENCE LEVELS OF A MACHINE LEARNING MODEL

(71) Applicant: DELL PRODUCTS L.P., Round Rock, TX (US)

(72) Inventors: Tyler Cox, Austin, TX (US); Jacob Mink, Cedar Park, TX (US); Spencer Bull, Conroe, TX (US)

(21) Appl. No.: 19/035,693

(22) Filed: Jan. 23, 2025

(51) Int. Cl. G06N 20/00

(52) U.S. Cl. CPC G06N 20/00

(57) ABSTRACT

An information handling system stores multiple usage samples and multiple datasets for a machine learning (ML) model. The system trains the ML model and provides the ML model to a model management framework (MMF). An MMF core of a processor within the MMF executes the ML model. The processor determines whether the execution of the ML model has a low confidence level. In response to the execution of the ML model having the low confidence level, the processor updates the usage samples for the ML model. In response to the execution of the ML model having a high confidence level, the processor stores the ML model in the memory.

### FIELD OF THE DISCLOSURE

The present disclosure generally relates to information handling systems, and more particularly relates to estimating and attributing confidence levels of a machine learning model within an information handling system.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

An information handling system may store multiple usage samples and multiple datasets for a machine learning (ML) model. The system may train the ML model and provide the ML model to a model management framework (MMF). A MMF core of a processor within the MMF may execute the ML model. The processor may determine a confidence level of the execution of the ML. In response to the execution of the ML model having a low confidence level, the processor may update the usage samples for the ML model. In response to the execution of the ML model having a high confidence level, the processor may store the ML model in the memory.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram of an information handling system according to at least one embodiment of the present disclosure;

FIG. 2 is a flow diagram of a method for estimating and attributing confidence levels to a machine learning (ML) model within an information handling system according to at least one embodiment of the present disclosure; and

FIG. 3 is a block diagram of a general information handling system according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

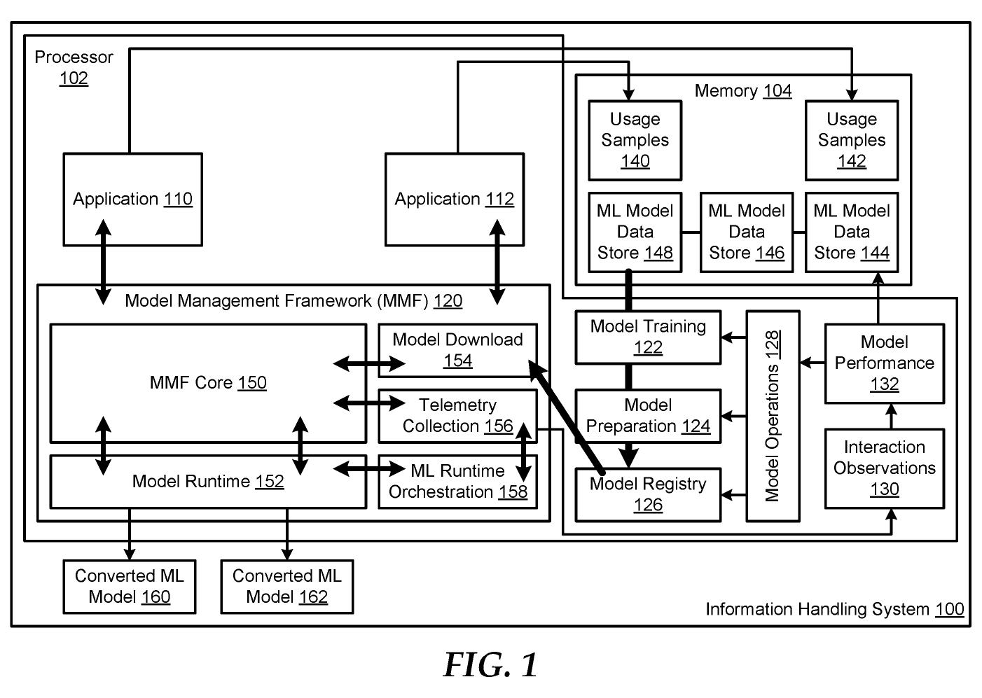

FIG. 1 illustrates an information handling system 100 according to at least one embodiment of the present disclosure. For purposes of this disclosure, an information handling system can include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (such as a desktop or laptop), tablet computer, mobile device (such as a personal digital assistant (PDA) or smart phone), server (such as a blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

Information handling system 100 includes a processor 102 and a memory 104. Processor 102 may execute multiple applications 110 and 112. Processor 102 may include different modules or components that the processor may execute to perform different operations. These modules or components included, but are not limited to, a model management framework (MMF) 120, a training model component 122, a model preparation component 124, a model registry component 126, a model operations component 128, an interaction observations component 130, and a model performance component 132. While these components are described as being integrated in processor 102, each of the components may be separate and individual hardware components within information handling system 100 without varying from the scope of this disclosure.

Memory 104 may store different data associated with a machine learning (ML) model including, but not limited to, application usage samples 140 and 142 and ML model datasets 144, 146, and 148. MMF 120 includes a MMF core, a model runtime module 152, a model download module 154, a telemetry collection module 156, and a model runtime orchestrator module 158. The operations described with respect to models 122-130 and 150-158 may be performed by processor 102. Information handling system 100 may include additional components without varying from the scope of this disclosure.

Artificial intelligence (AI) or ML models may be trained, tested, and validated on datasets that may be constructed of example inputs and desired or discouraged outputs. Previous information handling systems include various mechanisms in model conversion processes aimed at minimizing accuracy regression. These mechanisms include post-training quantization (PTQ) and quantization-aware training (QAT) specific operations. However, these operations in previous information handling systems do not take advantage of application usage samples or application usage observations in a multi-generational model system. Information handling system 100 is improved by processor 102 performing attribution and correction of a ML model by incorporating new samples into training, testing, and validation datasets. Processor 102 further improves information handling system 100 by utilizing errors observed from sessions in usage of models in a model preparation system, such as a specific model preparation pipeline. The training of ML models may be improved by processor 102 performing application usage aware model preparation from registered sample sources and incorporating scored usage observations as will be described herein.

Information handling system 100 is also improved by processor 102 performing operations to register, observe, and attribute the ML model based on multiple factors. These factors include, but are not limited to, model training, specialization, and conversion lineages. Additionally, processor 102 may generate and incorporate new training, tests, and validation data samples to improve the ML model creation process. Processor 110 may also accumulate semantic criticality of specific low confidence level scenarios for the output of the ML model, and these low confidence level scenarios may be used as triggers to re-initiate one or more model preparation steps as described herein.

During an initial training of a ML model, model training module 122 may access one or more of ML model datasets 144, 146, and 148. In an example, ML model datasets 144, 146, and 148 may be preloaded in memory 104 to enable training of the ML model. ML model datasets 144, 146, and 148 may include any suitable training data including, but not limited to, sample or test input data and sample or test output data. Model training module 122 may perform any operations known in the art to train the ML model based on ML model datasets 144, 146, and 148. After the ML model is trained, the trained model may be provided to model preparation module 124.

In an example, model preparation module 124 may be any suitable model preparation pipeline, such as a continuous integration and continuous delivery (CI/CD) pipeline. Model preparation module 124 may perform one or more operations on the ML model code to enable execution of the ML model by MMF core 150. In certain examples, the one or more operations of the pipeline in model preparation module 124 may be divided is individual steps of the pipeline. Model preparation module 124 may perform one or more model conversion processes of the ML model. These conversion processes include, but are not limited to, format changes, graph optimizations, and model quantization. In an example, the conversion process may result in data precision changes of the ML model.

Model registry module 126 may store and perform registration of the ML model and corresponding usage samples. In certain examples, registration of the ML by model registry module 126 may include any suitable operations to identify the current iteration of the ML model and mark the model as ready for execution. After the ML model and usage samples are registered, the ML model may be provided or pulled into MMF 120 by model download module 154. In an example, model download module 154 may provide the ML model to MMF core 150.

In an example, MMF core 150 may perform one or more executions the ML model. For example, MMF core 150 may execute the ML model on various hardware targets, such as a central processing unit (CPU), a graphics processing unit (GPU), a neural processing unit (NPU), or the like. Additionally, MMF core 150 may execute the ML model in conjunction with applications 110 and 112. During the execution of the ML model, application 110 may create application usage samples 142 and application 112 may create application usage samples 140. In certain examples, application usage samples 140 and 142 may differ based on the different interactions between the ML model and corresponding applications 110 and 112. Usage samples 140 and 142 may be stored in memory 104. Application usage samples 140 and 142 may be any suitable data associated with execution of the ML model by respective applications 110 and 112, such as sample outputs of the ML model based on sample inputs. In certain examples, applications 110 and 112 may create the application usage samples 140 and 142 over multiple iterations of the ML model. Each of the iterations of the ML model may include updates to the ML model based on updated usage samples 140 and 142 created during the execution of the previous ML model iterations. These updates to application usage samples 140 and 142 may include updating, removing, or adding new usage samples to the composite usage samples.

During the execution of the ML model, model runtime module 152 may track the runtimes of the ML model and provide the corresponding data to model runtime orchestration module 158. In an example, model runtime orchestration module 158 may determine whether the runtime of ML model matches corresponding or predetermined runtimes. In certain examples, the predetermined runtimes may be generated by model preparation module 124. ML runtime orchestration module 158 may provide data corresponding to the ML model runtimes to telemetry collection module 156.

In certain examples, telemetry collection module 156 may monitor or observe the execution of ML model by MMF core 150 and may collect application usage observations. Telemetry collection module 156 may store the application usage observations in interaction observations module 130. In certain examples, telemetry collection module 156 may collect or determine the application observations over multiple iterations of the ML model. Each of the iterations of the ML model may include updates to the ML model based on updates datasets 144, 146, and 148 created during the execution of the previous ML model iterations. These updates to ML model datasets 144, 146, and 148 may include updating, removing, or adding new datasets to composite ML model datasets.

In an example, model performance module 132 may perform one or more operations to create a performance of the ML model. For example, model performance module 132 may determine or create the performance of the ML model based on the application usage samples and the application usage observations. In certain examples, the ML model may be retrained based on the updated usage samples 140 and 142, the performance, and other datasets 144, 146, and 148.

Referring back to the execution of the ML model, MMF core 150 may score the usage samples and other results of the ML model. In an example, the score may be based on any suitable data collected during the execution of the ML model. For example, the telemetry collection component 156 may collect and analyze the outputs of the ML model, model runtime module 160, or the like. In certain examples, MMF core 150 may convert the analysis into a score identifying the accuracy of dataset samples 144, 146, and 148 from the ML model.

In an example, a component of processor 102 may determine a confidence level for an output generated by execution of the ML model. This determination may be made based on any suitable criteria. For example, the determination may be based on whether the score the ML model is below a threshold level. In this example, if the score is below the threshold, MMF core 150 may mark or identify a low confidence the input/output of the ML model. However, if the score is above the threshold, MMF core 150 may mark or identify a high confidence the input/output of the ML model.

If the output of the ML model has a low confidence level, the usage samples 140 and 142, usage observations, and datasets 144, 146, and 148 for the ML model may be updated. In an example, usage samples 140 and 142 may be based errors determined during execution of the ML model. In certain examples, applications 110 and 112 may update application usage samples 140 and 142 during each iteration of the ML model. Updated usage samples may be incorporated into both testing datasets 144, 146, and 148 and validation datasets for the ML model. In an example, processor 102 may attribute the low confidence of the ML model to a specific model preparation pipeline step within model preparation module 124. During the subsequent re-trainings of the ML model, updated usage samples 140 and 142 and updated datasets 144, 146, and 148 may improve model performance against usage scenarios or new information.

If the output of ML model has a confidence level, MMF core 150 or another component of processor 102 may validate the ML model and store the ML model as converted ML model 160 or 162. In an example, the ML model may be stored in memory 104 for later execution by application 110 or 112. If information handling system 100 is a remote or cloud server, processor 102 may provide the validated ML models 160 and 162 to one or more other information handling systems associated with the remote or cloud server. These other information handling systems may be personal computers of for individuals of a company or organization and the remote or cloud server may be an information technology server for the company or organization.

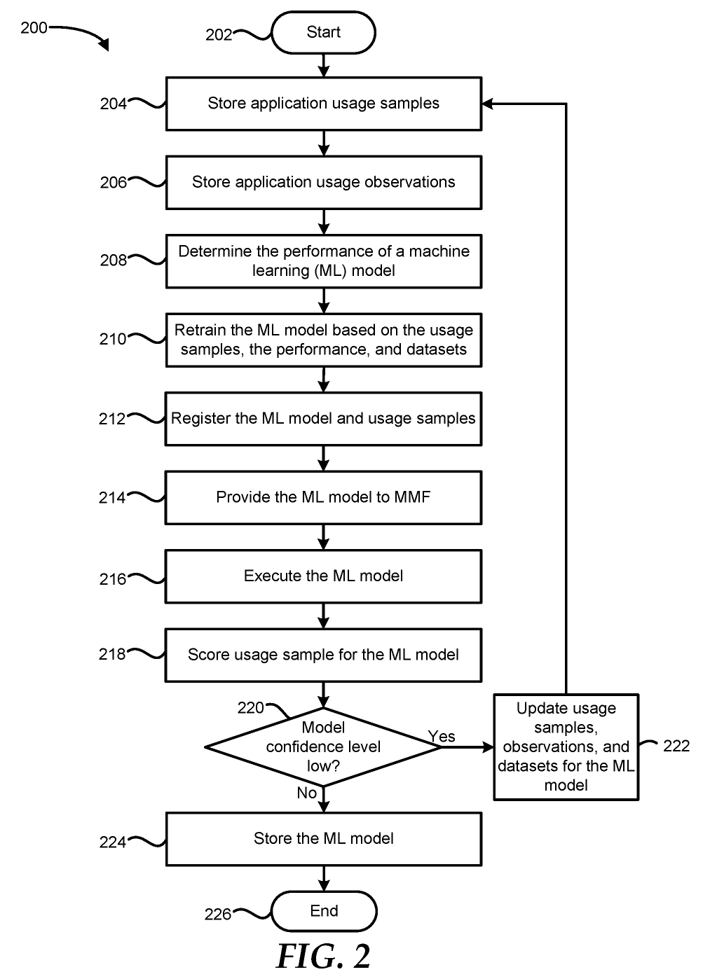

FIG. 2 shows a method 200 for estimating and attributing confidence levels to a ML model within an information handling system according to at least one embodiment of the present disclosure, starting at block 202. Not every method step set forth in this flow diagram is always necessary, and certain steps of the methods may be combined, performed simultaneously, in a different order, or perhaps omitted, without varying from the scope of the disclosure. FIG. 2 may be employed in whole, or in part, processor 102 of information handling system 100 in FIG. 1, or any other type of controller, device, module, processor, or any combination thereof, operable to employ all, or portions of, the method of FIG. 2.

At block 204, application usage samples are stored. In an example, the application usage samples may be created by an application executing one or more machine learning (ML) models. In certain examples, the application usage samples may be collected or created after a training session of the ML model and before the ML model is validated. The application usage samples may be any suitable data associated with execution of the ML model by the application, such as sample outputs of the ML model based on sample inputs.

At block 206, application usage observations are stored. In an example, the usage observations may be collected via any suitable component with the information handling. For example, usage observations may be collected by a telemetry collection component within a model management framework (MMF) in a processor of the information handling system. In certain examples, the application observations may be collected over multiple iterations of the ML model. Each of the iterations of the ML model may include updates to the ML model based on different datasets created during the execution of the previous ML model iterations.

At block 208, the performance of the ML model is determined. In an example, a processor of the information handling system may determine or create the performance of the ML model based on the application usage samples and the application usage observations. At block 210, the ML model is retrained based on the usage samples, the performance, and other datasets. After training the ML model, the ML model may be run through a model preparation pipeline to create an executable ML model. At block 212, the ML model and corresponding usage samples are registered. In certain examples, the registration of the ML model may include any suitable operations to identify the current iteration of the ML model and mark the model as ready for execution.

At block 214, the ML model is provided to the MMF of the information handling system. In an example, the MMF may include multiple components for executing and observing the ML model. For example, the MMF may include a MMF core, a model download component, the telemetry collection component, a ML runtime orchestrator component, model runtime component, or the like. In certain examples, the model download component may receive the ML model to enable execution of the ML model. At block 216, the ML model is executed. In an example, the MMF core may execute the ML model.

At block 218, the usage sample for the ML model is scored. In an example, the score may be based on any suitable data collected during the execution of the ML model. For example, the telemetry collection component may collect and analyze the outputs of the ML model, the runtime of the model, or the like. This analysis of the ML model may be converted into a score identifying the accuracy of dataset samples from the ML model.

At block 220, a determination is made whether the confidence level of the ML model inference score is low. This determination may be made based on any suitable criteria. For example, the determination may be based on whether the score the ML model is below a threshold level. In this example, if the score is below the threshold, the confidence level of the ML model may be marked as low. If the score is above the threshold, the confidence level of the ML model may be marked as high.

If the confidence level of the ML model is low, the usage samples, usage observations, and datasets for the ML model are updated at block 222 and the flow continues as described above at block 204. In an example, the usage samples may be based errors determined during execution of the ML model. In certain examples, the application usage samples may be updated during each iteration of the ML model. Updated usage samples may be incorporated into both testing datasets for the ML model and validation datasets for the ML model. In an example, a low confidence level of the ML model may be attributed to a specific model preparation pipeline step.

If the confidence level of the ML model is high, the ML model is validated and stored at block 224 and the flow ends at block 226. In an example, the ML model may be stored in a memory of the information handling system for later execution by one or more applications. If the information handling system is a remote or cloud server, the information handling system may provide the validated ML model to one or more other information handling systems associated with the remote or cloud server. These other information handling systems may be personal computers of for individuals of a company or organization and the remote or cloud server may be an information technology server for the company or organization.

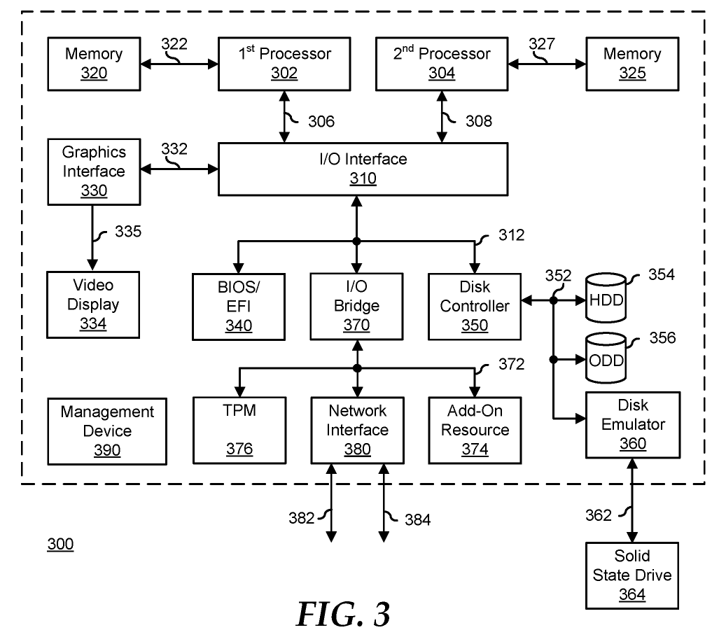

FIG. 3 shows a generalized embodiment of an information handling system 300 according to an embodiment of the present disclosure. Information handling system 300 may be substantially similar to information handling system 100 of FIG. 1. Further, information handling system 300 can include processing resources for executing machine-executable code, such as a central processing unit (CPU), a programmable logic array (PLA), an embedded device such as a System-on-a-Chip (SoC), or other control logic hardware. Information handling system 300 can also include one or more computer-readable medium for storing machine-executable code, such as software or data. Additional components of information handling system 300 can include one or more storage devices that can store machine-executable code, one or more communications ports for communicating with external devices, and various input and output (I/O) devices, such as a keyboard, a mouse, and a video display. Information handling system 300 can also include one or more buses operable to transmit information between the various hardware components.

Information handling system 300 can include devices or modules that embody one or more of the devices or modules described below and operates to perform one or more of the methods described below. Information handling system 300 includes a processors 302 and 304, an input/output (I/O) interface 310, memories 320 and 325, a graphics interface 330, a basic input and output system/universal extensible firmware interface (BIOS/UEFI) module 340, a disk controller 350, a hard disk drive (HDD) 354, an optical disk drive (ODD) 356 , a disk emulator 360 connected to an external solid state drive (SSD) 364, an I/O bridge 370, one or more add-on resources 374, a trusted platform module (TPM) 376, a network interface 380, a management device 390, and a power supply 395. Processors 302 and 304, I/O interface 310, memory 320, graphics interface 330, BIOS/UEFI module 340, disk controller 350, HDD 354, ODD 356, disk emulator 360, SSD 364, I/O bridge 370, add-on resources 374, TPM 376, and network interface 380 operate together to provide a host environment of information handling system 300 that operates to provide the data processing functionality of the information handling system. The host environment operates to execute machine-executable code, including platform BIOS/UEFI code, device firmware, operating system code, applications, programs, and the like, to perform the data processing tasks associated with information handling system 300.

In the host environment, processor 302 is connected to I/O interface 310 via processor interface 306, and processor 304 is connected to the I/O interface via processor interface 308. Memory 320 is connected to processor 302 via a memory interface 322. Memory 325 is connected to processor 304 via a memory interface 327. Graphics interface 330 is connected to I/O interface 310 via a graphics interface 332 and provides a video display output 336 to a video display 334. In a particular embodiment, information handling system 300 includes separate memories that are dedicated to each of processors 302 and 304 via separate memory interfaces. An example of memories 320 and 330 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 340, disk controller 350, and I/O bridge 370 are connected to I/O interface 310 via an I/O channel 312. An example of I/O channel 312 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 310 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/UEFI module 340 includes BIOS/UEFI code operable to detect resources within information handling system 300, to provide drivers for the resources, initialize the resources, and access the resources. BIOS/UEFI module 340 includes code that operates to detect resources within information handling system 300, to provide drivers for the resources, to initialize the resources, and to access the resources.

Disk controller 350 includes a disk interface 352 that connects the disk controller to HDD 354, to ODD 356, and to disk emulator 360. An example of disk interface 352 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 360 permits SSD 364 to be connected to information handling system 300 via an external interface 362. An example of external interface 362 includes a USB interface, an IEEE 4394 (Firewire) interface, a proprietary interface, or a combination thereof. Alternatively, solid-state drive 364 can be disposed within information handling system 300.

I/O bridge 370 includes a peripheral interface 372 that connects the I/O bridge to add-on resource 374, to TPM 376, and to network interface 380. Peripheral interface 372 can be the same type of interface as I/O channel 312 or can be a different type of interface. As such, I/O bridge 370 extends the capacity of I/O channel 312 when peripheral interface 372 and the I/O channel are of the same type, and the I/O bridge translates information from a format suitable to the I/O channel to a format suitable to the peripheral channel 372 when they are of a different type. Add-on resource 374 can include a data storage system, an additional graphics interface, a network interface card (NIC), a sound/video processing card, another add-on resource, or a combination thereof. Add-on resource 374 can be on a main circuit board, on separate circuit board or add-in card disposed within information handling system 300, a device that is external to the information handling system, or a combination thereof.

Network interface 380 represents a NIC disposed within information handling system 300, on a main circuit board of the information handling system, integrated onto another component such as I/O interface 310, in another suitable location, or a combination thereof. Network interface device 380 includes network channels 382 and 384 that provide interfaces to devices that are external to information handling system 300. In a particular embodiment, network channels 382 and 384 are of a different type than peripheral channel 372 and network interface 380 translates information from a format suitable to the peripheral channel to a format suitable to external devices. An example of network channels 382 and 384 includes InfiniBand channels, Fibre Channel channels, Gigabit Ethernet channels, proprietary channel architectures, or a combination thereof. Network channels 382 and 384 can be connected to external network resources (not illustrated). The network resource can include another information handling system, a data storage system, another network, a grid management system, another suitable resource, or a combination thereof.

Management device 390 represents one or more processing devices, such as a dedicated baseboard management controller (BMC) System-on-a-Chip (SoC) device, one or more associated memory devices, one or more network interface devices, a complex programmable logic device (CPLD), and the like, which operate together to provide the management environment for information handling system 300. In particular, management device 390 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 300, such as system cooling fans and power supplies. Management device 390 can include a network connection to an external management system, and the management device can communicate with the management system to report status information for information handling system 300, to receive BIOS/UEFI or system firmware updates, or to perform other task for managing and controlling the operation of information handling system 300.

Management device 390 can operate off of a separate power plane from the components of the host environment so that the management device receives power to manage information handling system 300 when the information handling system is otherwise shut down. An example of management device 390 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 390 may further include associated memory devices, logic devices, security devices, or the like, as needed, or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. An information handling system comprising:
a memory to store a plurality of usage samples and a plurality of datasets for a machine learning (ML) model; and
a processor to communicate with the memory, the processor to:
train the ML model;
provide the ML model to a model management framework (MMF);
execute the ML model in a MMF core of the processor within the MMF;
determine whether the execution of the ML model has a low confidence level;
in response to the execution of the ML model having the low confidence level, update the usage samples for the ML model; and
in response to the execution of the ML model having a high confidence level, store the ML model in the memory.

2. The information handling system of claim 1, wherein the processor further to retrain the ML based on the updated usage samples.

3. The information handling system of claim 1, wherein the usage samples are updated based errors determined during execution of the ML model.

4. The information handling system of claim 1, wherein the ML model is trained based on a plurality of application usage samples, a performance of a previous ML model, and a plurality of ML model datasets.

5. The information handling system of claim 4, wherein the processor further to create the performance of the previous ML model based on the application usage samples and a plurality of application observations.

6. The information handling system of claim 5, wherein the application observations are collected over multiple iterations of the ML model.

7. The information handling system of claim 1, wherein the processor further to:
incorporate the updated usage samples into testing datasets for the ML model; and
incorporate the updated usage samples into validation datasets for the ML model.

8. The information handling system of claim 1, wherein the determination of whether the execution of the ML model has the low confidence level includes the processor further to:
score a plurality of usage samples output during the execution of the ML model; and
based on the score of the usage samples, perform the determination of whether the execution of the ML model has the low confidence level.

9. The information handling system of claim 1, wherein the processor further to: attribute the low confidence level of the ML model to a specific model preparation pipeline step.

10. A method comprising:
storing, in an information handling system, a plurality of usage samples and a plurality of datasets for a machine learning (ML) model;
training, by the information handling system, the ML model;
providing the ML model to a model management framework (MMF);
executing the ML model in an MMF core of a processor within the MMF;
determining whether the execution of the ML model has a low confidence level;
in response to the execution of the ML model having the low confidence level, updating the usage samples for the ML model; and
in response to the execution of the ML model having a high confidence level, storing the ML model in the memory.

11. The method of claim 10, further comprising: retraining the ML based on the updated usage samples.

12. The method of claim 10, wherein the usage samples are updated based errors determined during execution of the ML model.

13. The method of claim 10, wherein the ML model is trained based on a plurality of application usage samples, a performance of a previous ML model, and a plurality of ML model datasets.

14. The method of claim 13, further comprising creating the performance of the previous ML model based on the application usage samples and a plurality of application observations.

15. The method of claim 14, wherein the application observations are collected over multiple iterations of the ML model.

16. The method of claim 10, further comprising:
incorporating the updated usage samples into testing datasets for the ML model; and
incorporating the updated usage samples into validation datasets for the ML model.

17. The method of claim 15, wherein the determining of whether the executing of the ML model has the low confidence level includes the method further comprising:
scoring a plurality of usage samples output during the executing of the ML model; and
based on the score of the usage samples, performing the determining of whether the executing of the ML model has the low confidence level.

18. The method of claim 10, further comprising attributing the low confidence level of the ML model to a specific model preparation pipeline step.

19. An information handling system comprising:
a memory to store a plurality of usage samples and a plurality of datasets for a machine learning (ML) model; and
a processor to:
train the ML model;
provide the ML model to a model management framework (MMF);
execute the ML model in an MMF core of the processor within the MMF;
determine whether the execution of the ML model has a low confidence level;
in response to the execution of the ML model having the low confidence level, update the usage samples for the ML model and retrain the ML based on the updated usage samples, wherein the usage samples are updated based errors determined during the execution of the ML model; and
in response to the execution of the ML model having a high confidence level, store the ML model in the memory.

20. The information handling system of claim 19, wherein the determination of whether the execution of the ML model has the low confidence level includes the processor further to:
score a plurality of usage samples output during the execution of the ML model; and
based on the score of the usage samples, perform the determination of whether the execution of the ML model has the low confidence level.
